(19) United States
(12) Patent Application Publication
(10) Pub. No.: US 2024/0375207 A1
(43) Pub. Date: Nov. 14, 2024

(54) DEVICES, SYSTEMS, AND METHODS FOR RESISTANCE WELDING

(71) Applicant: Sunstone Engineering LLC, Payson, UT (US)

(72) Inventors: Larin Amos Dodgen, Payson, UT (US); Scott Eugene Stubbs, Payson, UT (US); Marcos Luna Fernandez, Madrid (ES)

(21) Appl. No.: 18/196,862

(22) Filed: May 12, 2023

(51) Int. Cl. B23K 11/24; B23K 37/00

(52) U.S. Cl. CPC B23K 11/241; B23K 37/003

(57) ABSTRACT

A resistance welder may include a power input. A resistance welder may include a welding lead. A resistance welder may include a plurality of waveform modulators connected to the power input and the welding lead, each of the plurality of waveform modulators configured to receive input power from the power input and convert the input power into a welding output at the welding lead.

### CROSS-REFERENCE TO RELATED APPLICATIONS

N/A.

### BACKGROUND

Welding is the process of joining two metals. In some situations, welding occurs by heating the two metals to or past their melting points. The melted metals may mix and/or bind to each other, thereby joining the two metals. The metals may be heated in any manner. A non-exclusive and non-limiting list of welding systems may include arc welding, resistance welding, laser welding, or any other welding system.

### BRIEF SUMMARY

In some aspects, the techniques described herein relate to a resistance welding device. The resistance welding device includes a power input and a welding lead. A plurality of waveform modulators are connected to the power input and the welding lead. Each of the plurality of waveform modulators configured to receive input power from the power input and convert the input power into a welding output at the welding lead.

In some aspects, the techniques described herein relate to a resistance welding device. The resistance welding device includes an alternating current (AC) input power source. An input transformer and rectifier converts an AC input power from the AC input power source into a direct current (DC) input power. A plurality of waveform modulators are configured to convert the DC input power to a welding output. A plurality of modulator transformers are configured to step the welding output to a welding voltage of less than 10 V. A welding lead is connected to the plurality of modulator transformers to receive the welding output. The welding lead absorbs heat from the plurality of modulator transformers.

In some aspects, the techniques described herein relate to a method for resistance welding. A modulator controller converts an input current into a welding current using a plurality of waveform modulators. The welding current is converted to a welding voltage using a plurality of modulator transformers. The welding current is transferred to a welding lead for use in resistance welding.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic representation of a resistance welding system, according to at least one embodiment of the present disclosure;

FIG. 2 is a schematic representation of a welding device, according to at least one embodiment of the present disclosure;

FIG. 3 is a schematic representation of a welding device, according to at least one embodiment of the present disclosure;

FIG. 4-1 is a perspective cut-away view of a welding device, according to at least one embodiment of the present disclosure;

FIG. 4-2 is a rear view of the welding device of FIG. 4-1;

FIG. 5 is rear-facing cross-sectional view of a welding device, according to at least one embodiment of the present disclosure;

FIG. 6 is a representation of a modulator controller, according to at least one embodiment of the present disclosure; and

FIG. 7 is a flowchart of a method for welding, according to at least one embodiment of the present disclosure.

### DETAILED DESCRIPTION

This disclosure generally relates to devices, systems, and methods for a resistance welder. A resistance welder includes a plurality of waveform modulators. The waveform modulators may receive input power and convert the input power to a welding output having a particular welding waveform. The welding waveform may have a frequency of approximately 90 kHz. This may help to increase the control of the welding output, including the control of the output current, weld size, weld accuracy, weld consistency, metal temperature, upslope, downslope, hold time, any other aspect of the welding output, and combinations thereof.

In some embodiments, utilizing multiple waveform modulators may allow the resistance welder to receive welding feedback at an increased frequency. Increasing the welding feedback from the welding leads may further help to increase the control of the welding output. This may help to improve the quality of the welds, reduce wasted material, increased weld precision, and so forth.

In accordance with at least one embodiment of the present disclosure, each of the waveform modulators may transfer their output having the welding output to a modulator transformer. The modulator transformer may adjust the voltage of the welding output to the welding voltage. The welding voltage may be less than 10 V, or between 0.1 V and 10 V. Including a modulator transformer for each of the waveform modulator may reduce the size of the modulator transformer, thereby reducing the heat generation by each of the modulator transformer. In this manner, the duty cycle of the resistance welder may be increased and/or the size of the cooling system may be decreased.

In some embodiments, the resistance welder may transfer heat to a heat sink. The heat sink may be located within the housing of the welding unit. In some embodiments, the heat sink may include a massive block of material. The massive block of material may absorb heat generated by the waveform modulators and/or the modulator transformers. In some embodiments, the heat sink may have sufficient mass to absorb all of the heat generated by the waveform modulators and/or modulator transformers. For example, the waveform modulators may be thermally connected to the heat sink. In some embodiments, the heat sink may have sufficient mass to absorb all of the heat generated by the waveform modulators and/or the modulator transforms until the heat generation by the waveform modulators exceeds their heat transfer capacity to the heat sink. In some embodiments, the heat sink may be the welding leads. For example, the welding leads may be formed from a large block of metal (such as copper). The welding leads may absorb the generated heat while maintaining a temperature safe for a user to contact with his or her bare skin, such as below 50° C.

As illustrated by the foregoing discussion, the present disclosure utilizes a variety of terms to describe features and advantages of the resistance welding system. Additional detail is now provided regarding the meaning of such terms. For example, as used herein, the term “waveform modulator” refers to a device that receives electrical current as an input and changes the electrical current to have a particular output waveform. In particular, the term waveform modulator can include one or more switching mechanisms that turn the current on and off in a predetermined pattern. For example, the term waveform modulator may include a device or structure that includes one or more transistors, diodes, switches, any other switching mechanism, and combinations thereof.

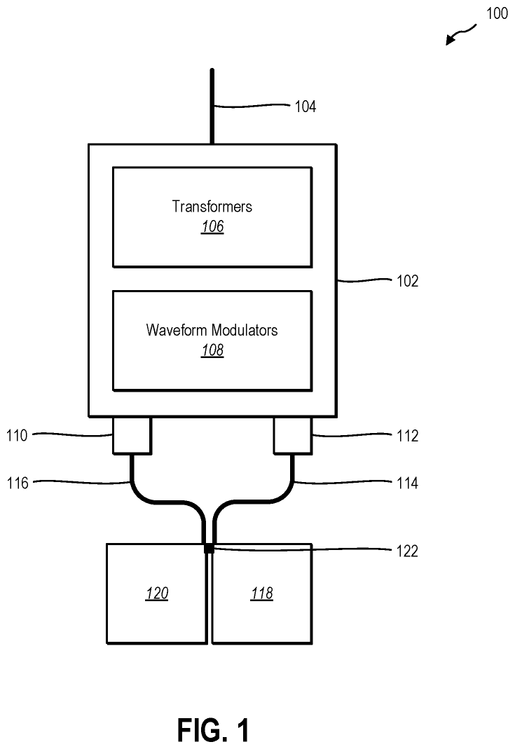

FIG. 1 is a schematic representation of a resistance welding system 100, according to at least one embodiment of the present disclosure. The resistance welding system 100 shown includes a welding device 102. The welding device 102 may be used to perform resistance welding activities.

The welding device 102 may receive input power from an AC input power source 104. The AC input power source 104 may provide power to the welding device 102 at any voltage. For example, the AC input power source 104 may provide input power to the welding device 102 having an input voltage of approximately 120 V, 240 V, 480 V, 600 V, any other input voltage, and combinations thereof. In some embodiments, the AC input power source 104 may provide 3-phase AC input power.

The welding device 102 may include one or more input transformers 106. The one or more input transformers 106 may step the voltage from the AC input power source 104 to an operating voltage. For example, a first transformer may normalize the input power to an input voltage, such as 400 V. The one or more input transformers 106 may further include a rectifier and an output filter to convert the input power to direct current (DC) input power.

Conventionally, a resistance welder may include a single waveform modulator having a single set of switching mechanisms. The conventional resistance welder may pass the entirety of the welding current through the single waveform modulator. A single modulator transformer may step the welding current down to the welding voltage. This conventional system may generate a significant amount of heat at one or both of the single modulator transformer and the single waveform modulator. The heat generation may accumulate at the single modulator transformer and/or the single waveform modulator until one or both of these elements are damaged. This may result in a reduced duty cycle for the conventional welder to reduce or prevent damage to the welder.

In accordance with at least one embodiment of the present disclosure, the welding device 102 includes a plurality of waveform modulators 108. The waveform modulators 108 may receive the converted DC input power. In some embodiments, the waveform modulators 108 may modulate the DC input power into a welding output having a welding waveform. For example, the switching mechanisms of the waveform modulators 108 may be selectively switched on and off to generate the welding waveform.

The waveform modulators 108 may be arranged in parallel. For example, the waveform modulators 108 may be arranged such that the current passed through each of the waveform modulators 108 may be added together to result in a total welding current at the welding leads 110, 112. In some embodiments, each of the waveform modulators 108 may operate using the same or approximately the same parameters and/or generate the same welding waveform. For example, each of the waveform modulators 108 may generate the same welding waveform. In some embodiments, different waveform modulators 108 may operate using different parameters and/or generate a different welding waveform. In some embodiments, one or more of the waveform modulators 108 may be bypassed such that they do not generate a welding waveform while the others are operating. As discussed herein, adjusting the waveform modulators 108 independently may increase the control of the welding device 102.

In some embodiments, the plurality of waveform modulators 108 may generate a combined welding current. In some embodiments, the combined welding current may be adjustable. The combined welding current may be any value, including 50 A, 100 A, 150 A, 200 A, 250 A, 500 A, 750 A, 1,000 A, 1250 A, 1,500 A, 1,750 A, 2,000 A, 2,250 A, 2,500 A, any other value, and combinations thereof. In some embodiments, the combined welding current may be any value between 50 A and 2,500 A. In some embodiments, the combined welding current may be adjustable between 50 A and 2,500 A.

In some embodiments, each of the waveform modulators 108 may operate with a modulator current. As discussed herein, the sum of the modulator currents may result in the welding current. In some embodiments, the modulator current for each of the waveform modulators 108 may be 10 A, 25 A, 50 A, 75 A, 100 A, 150 A, 200 A, 250 A, 300 A, 350 A, 400 A, 450 A, 500 A, or any value therebetween. In some embodiments, the modulator current may be any value between 10 A and 500 A. In some embodiments, the modulator current may be adjustable between 10 A and 500 A.

As discussed herein, each of the waveform modulators 108 may receive and/or pass a portion of the welding current through them. In this manner, because the waveform modulators 108 receive only a portion of the welding current, the waveform modulators 108 may generate a reduced amount of heat. Reducing the amount of heat generated may allow the welding device 102 to increase the duty cycle. For example, a conventional resistance welder may have a duty cycle of approximately 3% to 5% at a maximum current of 2,500 A. In accordance with at least one embodiment of the present disclosure, the welding devices 102 of the present disclosure may have an increased duty cycle of approximately 12%. In some embodiments, at a maximum current of 2,500 A, the duty cycle may include 12%. In some embodiments, the duty cycle may be 50%. An increased duty cycle may result in an increased productivity, decreased downtime, and/or decreased costs.

The waveform modulators 108 may output the welding output at the welding leads. The welding device 102 may include a positive lead 112 and a negative lead 110. A positive welding cable 114 may extend from the positive lead 112 and a negative welding cable 116 may extend from the negative lead 110. During welding, the positive welding cable 114 may be connected to a first metal plate 118 and the negative welding cable 116 may be connected to a second metal plate 120. While the first metal plate 118 and the second metal plate 120 are illustrated as plates, it should be understood that the resistance welding system 100 may weld any two metallic elements together, such as plates, rings, chains, cables, electronic components, any other metallic element, and combinations thereof.

To weld the first metal plate 118 to the second metal plate 120, the welding output from the waveform modulators 108 may be passed to the positive lead 112 and to the first metal plate 118 through the positive welding cable 114. The negative welding cable 116 may be placed on the second metal plate 120 so that the negative welding cable 116 is proximate the positive welding cable 114. When current is applied to the positive lead 112, an electric circuit may be formed from the positive welding cable 114 to the first metal plate 118 to the second metal plate 120 to the negative welding cable 116 to the negative lead 110.

The first metal plate 118 and the second metal plate 120 may have an electrical resistance. When the current is passed through the first metal plate 118 and the second metal plate 120, the resistance may cause the metal to heat. When the first metal plate 118 and the second metal plate 120 sufficiently heat, the metals may melt and fuse together. In this manner, the resistance welding system 100 may weld the first metal plate 118 to the second metal plate 120. As may be understood, the placement of the positive welding cable 114 and the negative welding cable 116 with respect to the first metal plate 118 and the second metal plate 120 may be adjusted to create any type of weld between the first metal plate 118 and the second metal plate 120.

In accordance with at least one embodiment of the present disclosure, the resistance welding device 102 may be a microwelder. A weld location 122 between the first metal plate 118 and the second metal plate 120 may be between 1 micrometer and 5 mm. In some embodiments, the weld thickness at the weld location 122 may be between 1 micrometer and 5 mm.

In some embodiments, the waveform modulators 108 may be operated at a high frequency. Operating the waveform modulators 108 at a high frequency may increase the control of the welding device 102. For example, a high frequency may allow the welding device 102 to have increased control over the upslope of the welding waveform, the downslope of the welding waveform, the hold time of the welding waveform, any other factor of the welding waveform, and combinations thereof. In some embodiments, a high frequency may increase the control over the resulting weld. For example, a high frequency may increase the control over the temperature of the weld location 122, the size of the weld location 122, the depth of the weld location 122, any other property of the weld location 122, and combinations thereof. In some embodiments, a high frequency may increase the control over the welding voltage and/or the welding current. Adjusting the welding voltage and/or the welding current may allow for adjustments to the weld location 122. For example, increasing the welding current may increase the penetration of a weld and/or weld thicker materials, and decreasing the welding current may allow welding of thinner materials.

For example, the waveform modulators 108 generate the welding output with a welding frequency of 75 kHz, 80 kHz, 90 kHz, 100 kHz, 110 kHz, 120 kHz, 125 kHz, 150 kHz, any other frequency, and combinations thereof. In some embodiments, the welding frequency may be between 75 kHz and 150 kHz. In some embodiments, the welding frequency may be between 80 kHz and 100 kHz. In some embodiments, the welding frequency may be approximately 90 kHz. In some embodiments, it may be critical that the welding frequency is approximately 90 kHz to increase the control of the welding device 102.

In some embodiments, the welding device 102 may receive feedback during welding activities. For example, the welding device 102 may receive feedback regarding the generated waveform. In some embodiments, the welding device 102 may receive feedback at a feedback frequency. In some embodiments, the feedback frequency may include 10 kHz, 15 kHz, 20 kHz, 25 kHz, 30 kHz, 35 kHz, 40 kHz, 45 kHz, 50 kHz, or any value therebetween. In some embodiments, the feedback frequency may help to improve the control and/or responsiveness of the welding device 102. For example, based on information received in the feedback, the welding device 102 may adjust one or more of the operation of the waveform modulators 108 to adjust the welding waveform and/or the output current. In some embodiments, it may be critical that the feedback frequency is approximately 25 kHz to increase the responsiveness and control of the welding device 102.

In some embodiments, in response to the feedback, the welding device 102 may adjust the operation of one or more of the waveform modulators 108. For example, the welding device 102 may adjust the amount of current that passes through one or more of the waveform modulators 108. This may help to adjust the total output current of the welding device 102. In some embodiments, the welding device 102 may cause the waveform modulators 108 to adjust the shape of the welding waveform, such as the upslope, the downslope, and/or the hold of the welding waveform.

In some embodiments, the welding device 102 may adjust a single waveform modulator 108 of the plurality of waveform modulators 108. For example, the welding device 102 may apply feedback to change the welding current by a small amount. To adjust the welding current by a small amount, the welding device 102 may cause a single waveform modulator 108 of the plurality of waveform modulators 108 to have a different modulator current. In this manner, utilizing multiple waveform modulators 108 may help to increase the control and/or responsiveness of the welding device 102.

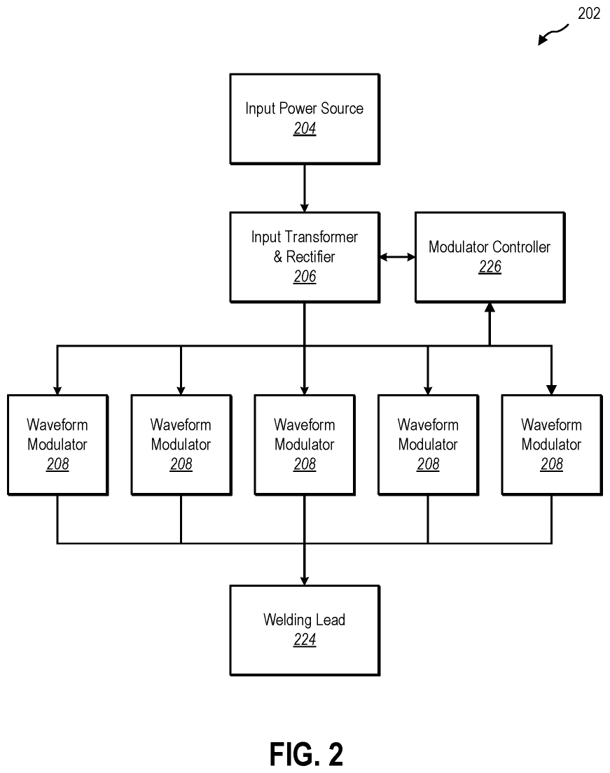

FIG. 2 is a schematic representation of a welding device 202, according to at least one embodiment of the present disclosure. The welding device 202 receives 3-phase AC input power from an input power source 204. The 3-phase AC input power is passed to an input transformer and rectifier 206. The input transformer and rectifier 206 may convert the AC input power to DC input power. As discussed herein, the input transformer may convert the AC input power from the input voltage to a converted input voltage. The converted input voltage may be approximately 400 V. The rectifier may convert the converted AC input power to DC input power having approximately 560 or 600 V.

The welding device 202 may pass the DC input power to multiple waveform modulators 208 located in parallel. For example, in the embodiment shown, the welding device 202 includes five waveform modulators 208. However, it should be understood that the welding device 202 may include any number of waveform modulators 208. For example, the welding device 202 may include 2, 3, 4, 5, 6, 7, 8, 9, 10, or more waveform modulators 208. The number of waveform modulators 208 may be based on the application of the welding device 202. For example, the number of waveform modulators 208 may be based on the desired welding current. In some embodiments, the number of waveform modulators 208 may be based on a desired duty cycle. Increasing the number of waveform modulators 208 may reduce the load on any single waveform modulators 208, thereby reducing the total heat generation. In some embodiments, increasing the number of waveform modulators 208 may allow for one or more waveform modulator 208 to be periodically switched off.

The waveform modulators 208 may adjust the DC input power into a welding current having a welding waveform with a welding frequency. Each of the waveform modulators 208 may be connected to the welding lead 224. The welding lead 224 may be used to direct the welding output to the plates or other elements to be welded. In some embodiments, the welding lead 224 may be a common lead, and each of the waveform modulators 208 may be connected to the common lead.

The welding device 202 may include a modulator controller 226. The modulator controller 226 may control operation of the waveform modulators 208. For example, the modulator controller 226 may control the formation of the welding waveform by controlling the actuation of the waveform modulators 208. In some examples, the modulator controller 226 may control the frequency of the waveform modulators 208. In some examples, the modulator controller 226 may control the modulator current of each of the waveform modulators 208. In some examples, the modulator controller 226 may control the total welding current at the welding lead 224. In some embodiments, the modulator controller 226 may control the shape of the welding waveform through control of the waveform modulators 208. In some examples, the modulator controller 226 may control the input DC power from the input transformer and rectifier 206, including the input DC voltage.

In some examples, the modulator controller 226 may receive feedback from one or more elements of the welding device 202. For example, the modulator controller 226 may receive feedback from the input transformer and rectifier 206, feedback from one or more of the waveform modulators 208, feedback from the welding lead 224, feedback from any other element of the welding device 202, and combinations thereof. In some embodiments, the feedback may be high frequency feedback, as discussed herein. from the waveform modulators 208. For example, the modulator controller 226 may

Using the feedback, the modulator controller 226 may adjust the welding output adjust the actuation of the waveform modulators 208 in response to the feedback. In this manner, the modulator controller 226 may utilize the waveform modulators 208 and/or the high-frequency feedback to increase the control over the welding device 202.

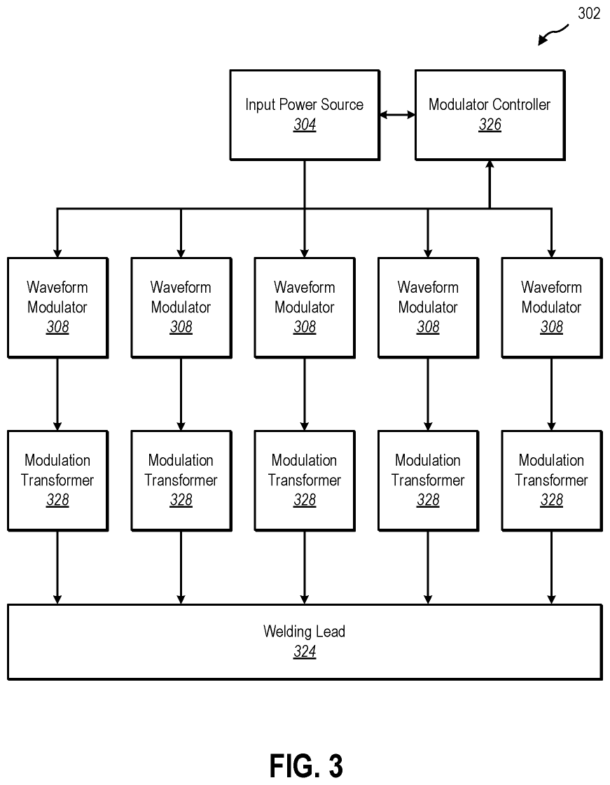

FIG. 3 is a schematic representation of a welding device 302, according to at least one embodiment of the present disclosure. The welding device 302 receives 3-phase AC input power from an input power source 304. As discussed herein, the 3-phase AC input power is passed to an input transformer and rectifier (e.g., input transformer and rectifier 206 of FIG. 2). The input transformer and rectifier may convert the AC input power to DC input power.

The welding device 302 may pass the DC input power to multiple waveform modulators 308 located in parallel. The welding device 302 may include a plurality of modulator transformers 328. The modulator transformers 328 may transform the welding output from the waveform modulators 308 to a welding voltage. The modulator transformers 328 may be connected to a welding lead 324. The modulator transformers 328 may transfer the welding waveform at the welding voltage to the welding lead 324. The welding lead 324 may be connected to the welding cables, which may be used to weld two pieces of metal together.

In accordance with at least one embodiment of the present disclosure, the modulator transformers 328 may generate heat when stepping the welding output down to the welding voltage. As discussed herein, conventional resistance welders utilize a single waveform modulator and a single transformer. The heat generated from the single waveform modulator and the single transformer may reduce the duty cycle of the resistance welder and/or increase the cooling system needed to manage the generated heat.

In accordance with at least one embodiment of the present disclosure, the welding device 302 may include multiple modulator transformers 328. Utilizing multiple modulator transformers 328 may help to reduce the amount of heat generated by each individual modulator transformer 328. The heat generated by each individual modulator transformer 328 may be more easily dissipated. This may help to increase the duty cycle of the welding device 302. In some embodiments, including multiple modulator transformers 328 may help to reduce the size and/or cooling capacity of the cooling system of the welding device 302. In some embodiments, the including multiple modulator transformers 328 may allow the 302 to not include any cooling system. Put another way, the welding device 302 may not include a cooling system. In some embodiments, including multiple modulator transformers 328 may help to reduce the size of the welding device 302. In some embodiments, including multiple modulator transformers 328 may increase the duty cycle of the welding device 302.

In accordance with at least one embodiment of the present disclosure, the welding lead 324 may be a heat sink for the welding device 302. The modulator transformers 328 may be directly connected to the welding lead 324. Heat generated by the modulator transformers 328 may be transferred to the welding lead 324. In some embodiments, the welding lead 324 may be formed of a massive block of material. The mass of the block of the welding lead 324 may absorb the generated heat by the modulator transformers 328.

The mass of the block of the welding lead 324 may have a heat capacity, which may be the amount of heat that the welding lead 324 may absorb. In some embodiments, the heat capacity of the welding lead 324 may be greater than the total amount of heat generated by the modulator transformers 328 during operation. The welding lead 324 has a heat dissipation, which may be the rate at which heat is dissipated away from the welding lead 324. In some embodiments, the rate of heat dissipation may be greater than the rate of heat generation of the modulator transformers 328.

In some embodiments, the heat capacity and/or heat dissipation of the welding lead 324 may be sufficient to maintain an operating temperature of the welding lead 324 that is safe for an operator to touch. For example, the heat capacity and/or heat dissipation of the welding lead 324 may be sufficient to maintain a temperature of less than or equal to 50° C. This may help to prevent injuries to the operator that may come into contact with the welding lead 324.

In some embodiments, the heat capacity and/or heat dissipation of the welding lead 324 may absorb the heat generated by the modulator transformers 328 until the diodes and/or transistors of the multiple waveform modulators 308 overheat during operation. Put another way, the welding lead 324 may absorb the generated heat until the diodes and/or transistors of the multiple waveform modulators 308 can no longer be cooled and/or dissipate heat into the environment faster than they generate heat.

Utilizing the welding lead 324 as a heat sink may help to increase the duty cycle of the welding device 302. In some embodiments, utilizing the welding lead 324 as a heat sink may help to reduce the size of and/or eliminate the cooling system in the welding device 302. This may help to reduce the size of the welding device 302 and/or improve the operability of the welding device 302.

The welding device 302 may include a modulator controller 326. The modulator controller 326 may control operation of the waveform modulators 308 and/or the modulator transformers 328. For example, the modulator controller 326 may control the formation of the welding waveform by controlling the actuation of the waveform modulators 308. In some examples, the modulator controller 326 may control the frequency of the waveform modulators 308. In some examples, the modulator controller 326 may control the modulator current of each of the waveform modulators 308. In some examples, the modulator controller 326 may control the total welding current at the welding lead 324. In some embodiments, the modulator controller 326 may control the shape of the welding waveform through control of the waveform modulators 308. In some examples, the modulator controller 326 may control the input DC power from the input transformer and rectifier, including the input DC voltage. In some embodiments, the modulator controller 326 may maintain each of the multiple waveform modulators 308 in phase. Put another way, the modulator controller 326 may help to control the actuation of the waveform modulators 308 so that the output welding current from each of the waveform modulators 308 is in phase or approximately in phase.

In some embodiments, the modulator controller 326 may control the output of the modulator transformers 328 to maintain the welding current output of the modulator transformers 328 in phase. Put another way, the modulator controller 326 may control the switching of the rectifier diodes of the modulator transformers 328 to maintain the synchronization of the welding output from the modulator transformers 328 For example, an FPGA may control the modulation signals to maintain the output from the transformers 328 at a delay of approximately 60° with each other. The synchronization may be maintained by a clock on the FPGA. This delay may help to allow canceling of the output current ripple, reducing or eliminating the use of an inductor-type output filter.

In some examples, the modulator controller 326 may receive feedback from one or more elements of the welding device 302. For example, the modulator controller 326 may receive feedback from input power source 304, feedback from one or more of the waveform modulators 308, feedback from one or more of the modulator transformers 328, feedback from the welding lead 324, feedback from any other element of the welding device 302, and combinations thereof. In some embodiments, the feedback may be high frequency feedback, as discussed herein.

Using the feedback, the modulator controller 326 may adjust the welding output from the waveform modulators 308. For example, the modulator controller 326 may adjust the actuation of the waveform modulators 308 in response to the feedback. In this manner, the modulator controller 326 may utilize the waveform modulators 308 and/or the high-frequency feedback to increase the control over the welding device 302.

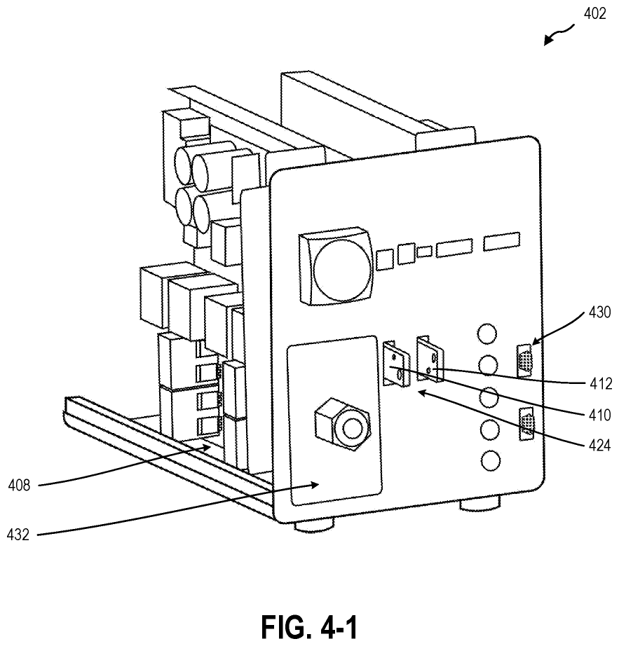

FIG. 4-1 is a perspective cut-away view of a welding device 402, according to at least one embodiment of the present disclosure. For ease of illustration, the welding device 402 shown has the top, side, and rear covers removed. The welding device 402 includes a plurality of I/O ports 430. The I/O ports 430 may be used to provide communication with external elements, such as a computing device, a controller, a cloud-based computing device and/or controller, any other external elements, and combinations thereof.

The welding device 402 includes a power input 432. The power input 432 may receive AC input power. As discussed herein, the welding device 402 may convert the AC input power into a welding output. The welding output may be routed to one or more welding leads 424, including a positive lead 412 and a negative lead 410. The operator may connect the welding cables to the welding leads 424. The operator may connect the welding cables to the elements to be welded, and the welding device 402 may apply the welding current to the welding leads 424 to weld two metallic elements together. As discussed herein, the welding device 402 includes a plurality of waveform modulators 408. The waveform modulators 408 may convert the input power into the welding waveform.

FIG. 4-2 is a perspective cut-away rear-view of the welding device 402 of FIG. 4-1. The waveform modulators 408 may be connected to one or more modulator transformers 428. The one or more modulator transformers 428 may transform the welding waveform to the welding voltage. In some embodiments, the one or more modulator transformers 428 may be a plurality of rectifier diodes 434. The rectifier diodes 434 may help to transmit the positive or the negative portions of the welding waveform at the welding voltage to the welding leads 424.

The rectifier diodes 434 may be connected to common busbar 436. The busbar 436 may be connected to the positive lead 412 of the welding leads 424. In this manner, the welding current may be transferred to the welding leads 424, where it may be used to perform welding activities.

As discussed herein, the welding leads 424 may form a heat-sink for the welding device 402. During operation, one or more of the waveform modulators 408, the modulator transformers 428, and the rectifier diodes 434 may generate heat. The heat may be transferred to the busbar 436, and the busbar 436 may transfer the heat to the welding leads 424. The welding leads 424 may receive the heat to maintain the welding leads 424, the modulator transformers 428, and/or the rectifier diodes 434 at an operating temperature. In some embodiments, the mass of the welding leads 424 may serve as the heat sink for the welding device 402. Put another way, the mass of the welding leads 424 may have a heat absorption that may exceed the heat generation of the welding device 402. In some embodiments, the welding leads 424 may maintain an operating temperature that is safe for an operator to touch. For example, the operator may touch the portion of the welding leads 424 extending from the front of the 402 (as seen in FIG. 4-1) without burning him or herself. In some examples, the welding leads 424 may maintain an operating temperature of less than or equal to approximately 50° C.

In the embodiment shown, the rectifier diodes 434 are connected to the positive lead of the welding leads 424. The rectifier diodes 434 may cause the positive portion of the transformed welding current to be passed to the positive lead of the welding leads 424. The negative lead of the welding leads 424 may be connected to the negative terminal of the modulator transformers 428.

In the embodiment shown, the welding device 402 does not include any cooling fans. The welding leads 424 may absorb the generated heat during and allow operation of the welding device 402 without active cooling. Put another way, the welding leads 424 may act as a passive cooling system. In some embodiments, the welding device 402 may have a duty cycle of up to 50%, or approximately 12% at 2,500 A, without any cooling fans or other active cooling elements.

In the embodiment shown, the welding device 402 includes two busbars 436. The busbars 436 are stacked vertically above and below the positive lead 412. Utilizing two busbars 436 may help to increase the heat transfer from the rectifier diodes 434 to the positive lead 412. In some embodiments, utilizing two busbars 436 stacked above and below the positive lead 412 may help allow an interior 438 of the welding device 402 to remain open. This may help the positive lead 412 and the negative lead 410 to dissipate heat into the interior 438, thereby increasing the cooling capacity of the welding leads 424.

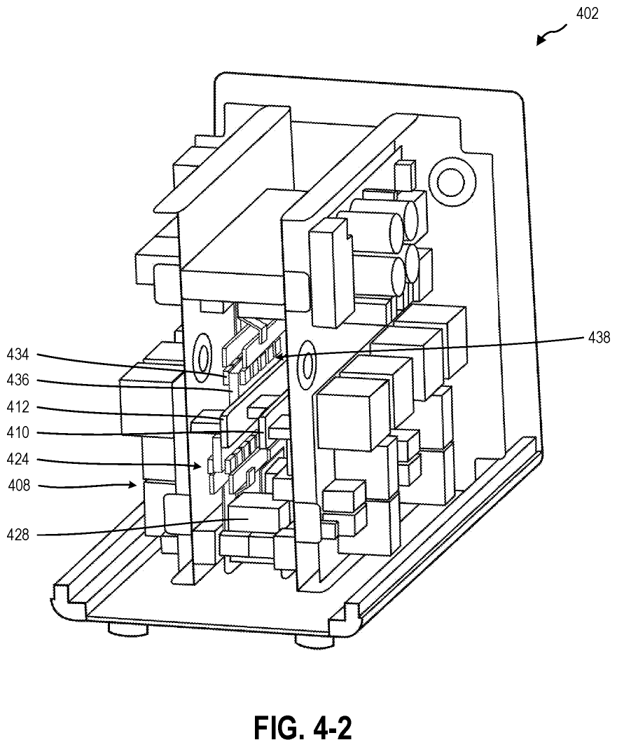

FIG. 5 is rear-facing cross-sectional view of a welding device 502, according to at least one embodiment of the present disclosure. As may be seen, the welding device 502 includes a plurality of waveform modulators (collectively 508) that are configured to receive an input power and convert the input power to a welding output. The waveform modulators 508 may be connected to a plurality of modulator transformers (collectively 528). The modulator transformers 528 may include and/or be connected to a plurality of rectifier diodes (collectively 534), which may transfer the positive portion of the welding waveform to a positive lead 512 of welding leads 524. The positive lead 512 may be connected to a positive welding cable, and a negative welding cable may be connected to a negative welding lead 510. When the circuit is closed through the welding cables, the welding current may pass from the positive lead 512 to the negative welding lead 510. The current may heat the metals to which the welding leads 524 are connected, thereby welding the metals together.

As discussed herein, the welding device 502 includes a plurality of waveform modulators 508. The welding device 502 shown includes a first waveform modulator 508-1. The first waveform modulator 508-1 may be connected to a first modulator transformer 528-1, which may be connected to a first set of rectifier diodes 534-1. The first set of rectifier diodes 534-1 may be connected to a first busbar 536-1, which is connected to the positive lead 512. In the embodiment shown, the first waveform modulator 508-1, the first modulator transformer 528-1, the first set of rectifier diodes 534-1, and the first busbar 536-1 are located in an upper portion of the welding device 502.

The welding device 502 shown includes a second waveform modulator 508-2. The second waveform modulator 508-2 may be connected to a second modulator transformer 528-2, which may be connected to a second set of rectifier diodes 534-2. The second set of rectifier diodes 534-2 may be connected to a second busbar 536-2, which is connected to the positive lead 512. In the embodiment shown, the second waveform modulator 508-2, the second modulator transformer 528-2, the second set of rectifier diodes 534-2, and the second busbar 536-2 are located in a lower portion of the welding device 502.

In some embodiments, the welding device 502 may include multiple upper waveform modulators 508 located in the upper portion and multiple lower waveform modulators 508 located in the lower portion. In some embodiments, the welding device 502 may include multiple upper modulator transformers 528 located in the upper portion and multiple lower modulator transformers 528 located in the lower portion. In some embodiments, upper waveform modulators 508 may be connected to upper modulator transformers 528 and lower waveform modulators 508 may be connected to lower modulator transformers 528. In some embodiments, upper waveform modulators 508 may be connected to lower modulator transformers 528 and lower waveform modulators 508 may be connected to upper modulator transformers 528.

As may be seen, the first busbar 536-1 and the second busbar 536-2 may form a T-structure with the positive lead 512. This may help to reduce the amount of space that the positive lead 512 occupies. In some embodiments, this may help to open up the interior 538 of the welding device 502. Opening up the interior 538 may help to increase the heat dissipation of the welding leads 524.

In the embodiment shown, the welding device 502 includes a plurality of cooling fans 540. The cooling fans 540 may pass air over and/or across the elements of the welding device 502. For example, the cooling fans 540 may pass air across the welding leads 524, the upper modulator transformers 528, the waveform modulators 508, and other portions of the welding device 502. In some embodiments, air from the cooling fans 540 may collect heat from the elements of the welding device 502 and pass the heat out of the welding device 502.

In the embodiment shown, the welding device 502 includes three cooling fans 540. However, it should be understood that the welding device 502 may include any number of cooling fans 540, including 1, 2, 3, 4, 5, 6, 7, 8, 9, 10, or more cooling fans 540. In the embodiment shown, air from a central cooling fan 540 may pass across the welding leads 524 and help to dissipate heat absorbed by the heat-sink welding leads 524.

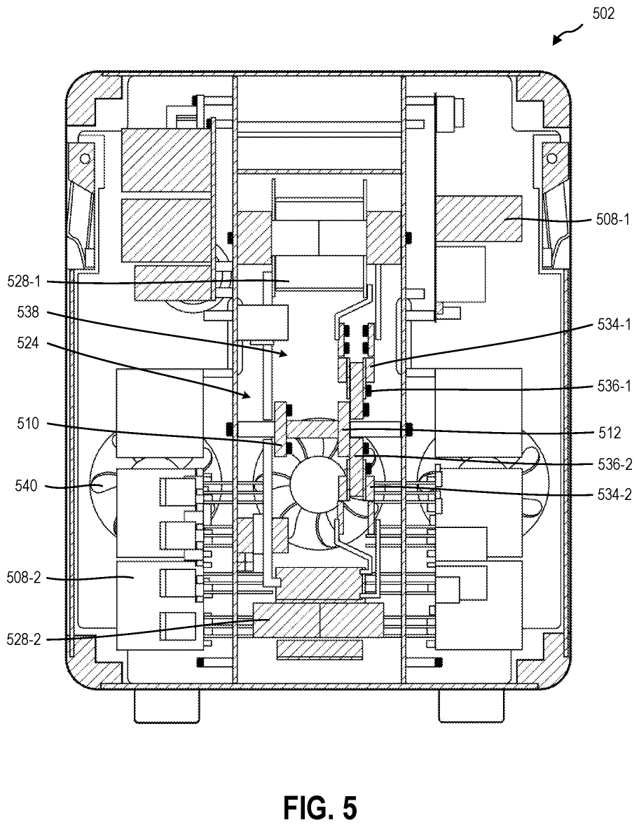

FIG. 6 is a representation of a modulator controller 626, according to at least one embodiment of the present disclosure. Each of the components of the modulator controller 626 can include software, hardware, or both. For example, the components can include one or more instructions stored on a computer-readable storage medium and executable by processors of one or more computing devices, such as a client device or server device. When executed by the one or more processors, the computer-executable instructions of the modulator controller 626 can cause the computing device(s) to perform the methods described herein. Alternatively, the components can include hardware, such as a special-purpose processing device to perform a certain function or group of functions. Alternatively, the components of the modulator controller 626 can include a combination of computer-executable instructions and hardware.

Furthermore, the components of the modulator controller 626 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The modulator controller 626 may control the welding output of a resistance welding device. The modulator controller 626 may include a modulator manager 642. The modulator manager 642 may control operation of one or more waveform modulators. For example, the modulator manager 642 may control actuation of the switching devices of the waveform modulators. The modulator manager 642 may control actuation of the waveform modulators to generate a particular welding waveform, including the upslope, the downslope, the hold time, any other aspect of the welding waveform, and combinations thereof.

In some embodiments, the modulator manager 642 may control the frequency of the welding waveform. For example, the modulator manager 642 may control how fast each of the switching mechanisms switch while generating the welding waveform. In some embodiments, the modulator manager 642 may generate the welding waveform with a high frequency, such as 90 kHz.

The modulator controller 626 may include and/or receive measurements from one or more feedback sensors 644. The feedback sensors 644 may receive information from portions of the welding device. For example, the feedback sensors 644 may receive voltage information, current information, welding waveform information, operating temperature information, weld temperature, any other operating information, and combinations thereof.

Using the feedback information, the modulator manager 642 may adjust the welding waveform. For example, the modulator manager 642 may adjust the frequency, current, shape, upslope, downslope, hold time, any other aspect of the welding waveform, and combinations thereof. In this manner, the feedback sensors 644 and the modulator manager 642 may help to improve the responsiveness and control of the welding device. This may help to improve the accuracy, shape, size, depth, temperature, any other aspect, and combinations thereof, of the welds performed by the welding device.

The modulator controller 626 may include a transformer manager 646. The transformer manager 646 may control operation of the transformers of the welding device. For example, the transformer manager 646 may control the operation of the input transformer and rectifier. This may help to control the input voltage or other aspect of the input current. In some examples, the transformer manager 646 may control the operation of the modulator transformers. For example, the transformer manager 646 may control the welding voltage, which may impact the welding current. In some embodiments, the modulator controller 626 may include a welding manager 648. The welding manager 648 may manage any other aspect of the welding device. In some embodiments, the welding manager 648 may control the welding current.

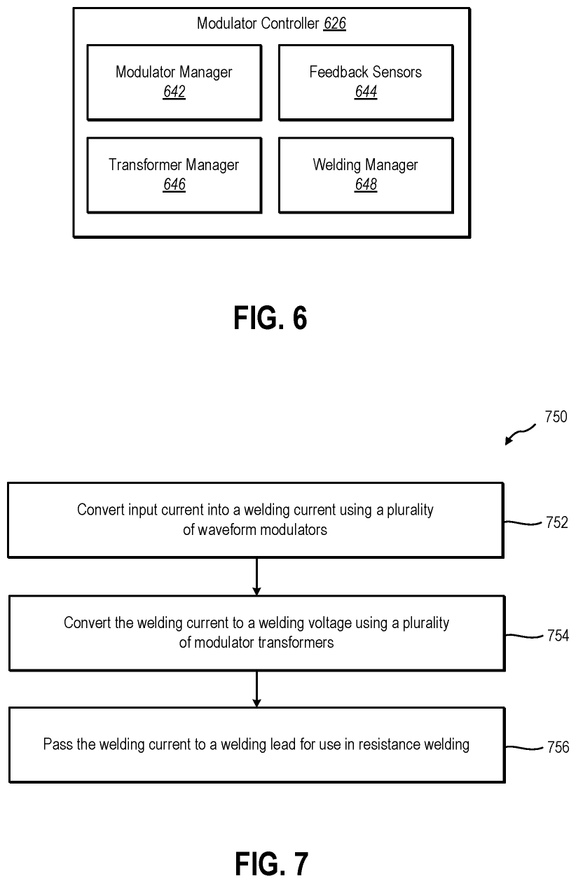

FIG. 7 is a flowchart of a method 750 for welding, according to at least one embodiment of the present disclosure. FIG. 7, the corresponding text, and the examples provide a number of different methods, systems, devices, and non-transitory computer-readable media of the modulator controller 626. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts for welding in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

The modulator controller may cause a welding device to convert input current into a welding current using a plurality of waveform modulators at 752. In some embodiments, each of the plurality of waveform modulators converts a portion of the input current to a welding output having a welding current of between 10 A and 500 A.

The modulator controller may cause the welding device to covert the welding current to a welding voltage using a plurality of modulator transformers at 754. The welding current may be transferred to a welding lead for use in resistance welding at 756.

In some embodiments, the welding device may transfer heat from the plurality of modulator transformers to the welding lead. In some embodiments, the welding device may maintain an operating temperature of the welding lead at or below 50° C. In some embodiments, the method may further include operating the plurality of modulator transformers with a duty cycle of approximately 12%.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A resistance welding device, comprising:
a power input;
a welding lead; and
a plurality of waveform modulators connected to the power input and the welding lead, each of the plurality of waveform modulators configured to receive input power from the power input and convert the input power into a welding output at the welding lead.

2. The resistance welding device of claim 1, the welding output having a welding waveform with a welding frequency of greater than or equal to 90 kHz and a welding voltage of less than 10 V.

3. The resistance welding device of claim 2, wherein each of the plurality of waveform modulators generates the same welding waveform.

4. The resistance welding device of claim 2, wherein the plurality of waveform modulators have a combined welding current of between 50 A and 2,500 A.

5. The resistance welding device of claim 1, further comprising a plurality of modulator transformers between the plurality of waveform modulators and the welding lead, each of the plurality of modulator transformers maintaining a welding voltage for the welding output.

6. The resistance welding device of claim 5, wherein the plurality of modulator transformers include a plurality of rectifier diodes connected to a busbar.

7. The resistance welding device of claim 6, wherein the welding lead includes a positive lead and a negative lead, and wherein the busbar is connected to the positive lead.

9. The resistance welding device of claim 8, wherein the welding lead is the heat sink.

8. The resistance welding device of claim 1, further comprising a heat sink, each of the plurality of waveform modulators thermally connected to the heat sink.

10. The resistance welding device of claim 1, wherein the welding device generates a weld location of between 1 micrometer and 5 millimeters.

11. A resistance welding device, comprising:
an alternating current (AC) input power source;
an input transformer and rectifier to convert an AC input power from the AC input power source into a direct current (DC) input power;
a plurality of waveform modulators configured to convert the DC input power to a welding output;
a plurality of modulator transformers configured to step the welding output to a welding voltage of less than 10 V; and
a welding lead connected to the plurality of modulator transformers to receive the welding output, the welding lead absorbing heat from the plurality of modulator transformers.

12. The resistance welding device of claim 11, wherein the welding output at the welding lead has a welding current of between 50 A and 2,500 A.

13. The resistance welding device of claim 11, wherein the welding lead maintains an operating temperature of less than 50° C.

14. The resistance welding device of claim 11, wherein the resistance welding device does not include a cooling fan.

15. The resistance welding device of claim 14, wherein the plurality of waveform modulators and the plurality of modulator transformers have a duty cycle of 12%.

16. A method for resistance welding, comprising:
converting an input current into a welding current using a plurality of waveform modulators;
converting the welding current to a welding voltage using a plurality of modulator transformers; and
transferring the welding current to a welding lead for use in resistance welding.

17. The method of claim 16, further comprising transferring heat from the plurality of modulator transformers to the welding lead.

18. The method of claim 17, wherein transferring the heat includes maintaining an operating temperature of the welding lead below 50° C.

19. The method of claim 16, further comprising operating the plurality of modulator transformers with a duty cycle of approximately 12%.

20. The method of claim 16, wherein converting the input current into the welding current includes each of the plurality of waveform modulators converting a portion of the input current into a portion of the welding current having a current of between 10 A and 500 A.
